(19) United States
(12) Patent Application Publication
(10) Pub. No.: US 2025/0316103 A1
(43) Pub. Date: Oct. 9, 2025

(54) METHOD FOR EVALUATING MODEL PERFORMANCE, METHOD FOR TRAINING MODEL, AND ELECTRONIC DEVICE

(71) Applicant: BEIJING BAIDU NETCOM SCIENCE TECHNOLOGY CO., LTD., Beijing (CN)

(72) Inventors: Mengyue LIU, Beijing (CN); Penghao ZHAO, Beijing (CN); En SHI, Beijing (CN); Shupeng LI, Beijing (CN)

(21) Appl. No.: 19/242,633

(22) Filed: Jun. 18, 2025

(30) Foreign Application Priority Data
Sep. 20, 2024 (CN) 202411320605.9

(51) Int. Cl. G06V 30/19; G06V 10/74; G06V 10/774; G06V 10/776; G06V 10/82; G06V 30/30

(52) U.S. Cl. CPC G06V 30/1916; G06V 10/761; G06V 10/774; G06V 10/776; G06V 10/82; G06V 30/19093; G06V 30/19147; G06V 30/30

(57) ABSTRACT

A method for evaluating model performance, a method for training a model, and an electronic device are provided, which relate to a field of artificial intelligence technology, in particular to fields of deep learning, computer vision and optical character recognition technologies. The specific implementation includes: in response to a model performance evaluation request for a target model, performing optical character recognition on an object to be recognized contained in an annotated image using the target model to obtain a first structured string, where a label of the annotated image is a second structured string obtained by annotating the object to be recognized; calculating a similarity between the first structured string and the second structured string using a Siamese network to obtain a similarity value between the first structured string and the second structured string; and obtaining a performance evaluation result of the target model based on the similarity value.

### CROSS-REFERENCE TO RELATED APPLICATION(S)

This application claims the benefit of Chinese Patent Application No. 202411320605.9 filed on Sep. 20, 2024, the whole disclosure of which is incorporated herein by reference.

### TECHNICAL FIELD

The present disclosure relates to a field of artificial intelligence technology, in particular to fields of deep learning, computer vision and optical character recognition technologies, and specifically to a method for evaluating model performance, a method for training a model, and an electronic device.

### BACKGROUND

Optical Character Recognition (OCR) is a technology that converts text in images into machine-readable text. This technology may reduce the need for manual data entry and improve data processing efficiency by automatically extracting text from scanned documents, photos and files.

### SUMMARY

The present disclosure provides a method for evaluating model performance, a method for training a model, and an electronic device.

According to an aspect of the present disclosure, a method for evaluating model performance is provided, including: in response to a model performance evaluation request for a target model, performing optical character recognition on an object to be recognized contained in an annotated image using the target model to obtain a first structured string, where a label of the annotated image is a second structured string obtained by annotating the object to be recognized; calculating a similarity between the first structured string and the second structured string using a Siamese network to obtain a similarity value between the first structured string and the second structured string; and obtaining a performance evaluation result of the target model based on the similarity value between the first structured string and the second structured string.

According to another aspect of the present disclosure, a method for training a model is provided, including: acquiring a plurality of sample pairs, where the sample pair includes two structured strings, and a label of the sample pair indicates a degree of similarity between the two structured strings in the sample pair; and training an initial network using the plurality of sample pairs to obtain a Siamese network.

According to another aspect of the present disclosure, an electronic device is provided, including: at least one processor; and a memory communicatively connected to the at least one processor, where the memory stores instructions executable by the at least one processor, and the instructions are configured to, when executed by the at least one processor, cause the at least one processor to implement the methods described above.

According to another aspect of the present disclosure, a non-transitory computer-readable storage medium having computer instructions therein is provided, and the computer instructions are configured to cause a computer to implement the methods described above.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure. In the accompanying drawings:

FIG. 1 schematically shows an exemplary system architecture to which a method and apparatus for evaluating model performance and a method and apparatus for training a model may be applied according to an embodiment of the present disclosure;

FIG. 2 schematically shows a flowchart of a method for evaluating model performance according to an embodiment of the present disclosure;

FIG. 3 schematically shows a flowchart of determining a similarity value according to an embodiment of the present disclosure;

FIG. 4 schematically shows a flowchart of a method for training a model according to an embodiment of the present disclosure;

FIG. 5A schematically shows an image of a formula object compiled from an initial structured string according to an embodiment of the present disclosure;

FIG. 5B schematically shows an image of a formula object compiled from a first structured string according to an embodiment of the present disclosure;

FIG. 5C schematically shows an image of a formula object compiled from a first structured string according to another embodiment of the present disclosure;

FIG. 5D schematically shows an image of a formula object compiled from a second structured string according to an embodiment of the present disclosure;

FIG. 5E schematically shows an image of a formula object compiled from a second structured string according to another embodiment of the present disclosure;

FIG. 6 schematically shows a schematic diagram of adjusting model parameters of an initial network according to an embodiment of the present disclosure;

FIG. 7 schematically shows a schematic diagram of removing a target sample pair from a training set according to an embodiment of the present disclosure;

FIG. 8 schematically shows a block diagram of an apparatus for evaluating model performance according to an embodiment of the present disclosure;

FIG. 9 schematically shows a block diagram of an apparatus for training a model according to an embodiment of the present disclosure; and

FIG. 10 schematically shows a block diagram of an electronic device suitable for implementing a method for evaluating model performance and a method for training a model according to an embodiment of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

When processing documents especially academic papers using OCR technology, it is generally necessary to recognize a large number of mathematical formulas. Because mathematical formulas include special characters such as Greek letters, Latin letters, mathematical symbols, etc., and the format of mathematical formulas significantly differs from that of ordinary text, it is difficult to ensure the accuracy of mathematical formulas obtained using OCR technology. A recognition effect of an OCR model on mathematical formulas may be detected by calculating a text edit distance, so as to ensure high usability and accuracy of the mathematical formulas.

However, the text edit distance is calculated based only on surface differences between characters, and different typesetting and formats may have a significant impact on the calculation of text edit distance. Mathematical formulas typically have multiple representation methods, and there may be edit distances between different representation methods, thus affecting evaluation results.

In addition, symbols in mathematical formulas have specific mathematical meanings and priorities. As text edit distance does not adequately take into account the particularity of symbols, evaluating model performance using text edit distance may further increase differences and lead to inaccurate evaluation results.

In view of this, an embodiment of the present disclosure provides a method and apparatus for evaluating model performance, a method and apparatus for training a model, and an electronic device. The method for evaluating model performance includes: in response to a model performance evaluation request for a target model, performing optical character recognition on an object to be recognized contained in an annotated image using the target model to obtain a first structured string, where a label of the annotated image is a second structured string obtained by annotating the object to be recognized; calculating a similarity between the first structured string and the second structured string using a Siamese network to obtain a similarity value between the first structured string and the second structured string; and obtaining a performance evaluation result of the target model based on the similarity value between the first structured string and the second structured string.

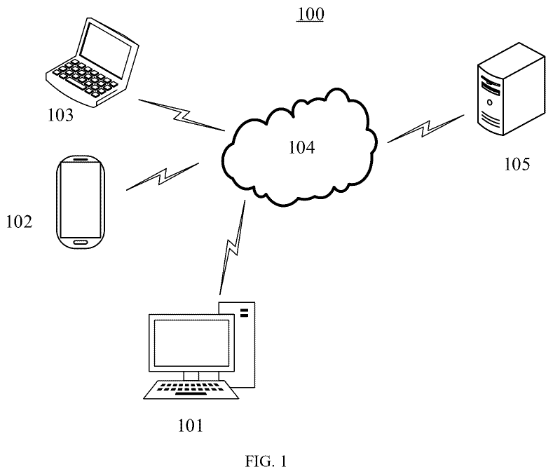

FIG. 1 schematically shows an exemplary system architecture to which a method and apparatus for evaluating model performance and a method and apparatus for training a model may be applied according to an embodiment of the present disclosure.

It should be noted that FIG. 1 is merely an example of the system architecture to which an embodiment of the present disclosure may be applied, so as to help those skilled in the art understand technical contents of the present disclosure. However, it does not mean that embodiments of the present disclosure may not be applied to other devices, systems, environments or scenarios. For example, in another embodiment, the exemplary system architecture to which the method and apparatus for evaluating model performance and the method and apparatus for training a model may be applied may include a terminal device, but the terminal device may implement the method and apparatus for evaluating model performance and the method and apparatus for training a model provided in embodiments of the present disclosure without interacting with a server.

As shown in FIG. 1, the system architecture 100 according to such embodiments may include terminal devices 101, 102 and 103, a network 104, and a server 105. The network 104 is a medium for providing a communication link between the terminal devices 101, 102, 103 and the server 105. The network 104 may include various connection types, such as wired and/or wireless communication links, etc.

The terminal devices 101, 102 and 103 may be used by users to interact with the server 105 through the network 104 to receive or send messages, etc. The terminal devices 101, 102 and 103 may be installed with various communication client applications, such as knowledge reading applications, web browser applications, search applications, instant messaging tools, email clients and/or social platform software, etc. (for example only).

The terminal devices 101, 102 and 103 may be various electronic devices having display screens and supporting web browsing, including but not limited to smart phones, tablet computers, laptop computers, and desktop computers, etc.

The server 105 may be a server providing various services, such as a background management server (for example only) that provides a support for content browsed by users using the terminal devices 101, 102 and 103. The background management server may analyze and process received data such as a user request, and feed back a processing result (such as a web page, information or data acquired or generated according to the user request) to the terminal devices.

It should be noted that the method for evaluating model performance and the method for training a model provided in embodiments of the present disclosure may generally be performed by the terminal device 101, 102 or 103. Accordingly, the apparatus for evaluating model performance and the apparatus for training a model provided in embodiments of the present disclosure may also be arranged in the terminal device 101, 102 or 103.

Alternatively, the method for evaluating model performance and the method for training a model provided in embodiments of the present disclosure may generally be performed by the server 105. Accordingly, the apparatus for evaluating model performance and the apparatus for training a model provided in embodiments of the present disclosure may generally be arranged in the server 105. The method for evaluating model performance and the method for training a model provided in embodiments of the present disclosure may also be performed by a server or server cluster different from the server 105 and capable of communicating with the terminal device 101, 102, 103 and/or the server 105. Accordingly, the apparatus for evaluating model performance and the apparatus for training a model provided in embodiments of the present disclosure may also be arranged in a server or server cluster different from the server 105 and capable of communicating with the terminal device 101, 102, 103 and/or the server 105.

It should be understood that the number of terminal devices, networks and servers in FIG. 1 is merely illustrative. According to implementation needs, any number of terminal devices, networks and servers may be provided.

In technical solutions of the present disclosure, a collection, a storage, a use, a processing, a transmission, a provision, a disclosure, an application and other processing of user personal information involved comply with provisions of relevant laws and regulations, take necessary security measures, and do not violate public order and good customs.

In the technical solutions of the present disclosure, the acquisition or collection of user personal information has been authorized or allowed by users.

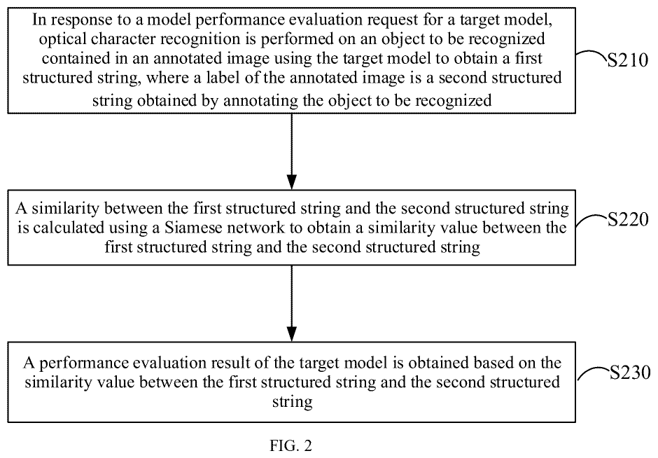

FIG. 2 schematically shows a flowchart of a method for evaluating model performance according to an embodiment of the present disclosure.

As shown in FIG. 2, the method includes operation S210 to operation S230.

In operation S210, in response to a model performance evaluation request for a target model, optical character recognition is performed on an object to be recognized contained in an annotated image using the target model to obtain a first structured string, where a label of the annotated image is a second structured string obtained by annotating the object to be recognized.

According to an embodiment of the present disclosure, the model performance evaluation request may be issued by a user to evaluate performance of the target model in performing optical character recognition.

According to an embodiment of the present disclosure, the target model is used to perform optical character recognition on the object to be recognized contained in the annotated image and output a first structured string. The first structured string output by the target model may be in LaTeX format. LaTeX is a typesetting system that may accurately and clearly typeset mathematical symbols and structures in mathematical formulas. The annotated image may be an image containing a large amount of text and formulas, such as a textbook page, a paper page, etc. The object to be recognized may be an object in the annotated image that is difficult to accurately recognize using traditional optical character recognition methods.

According to an embodiment of the present disclosure, the second structured string may be determined by manually analyzing the object to be recognized in the annotated image, and the second structured string has the same format as the first structured string.

In operation S220, a similarity between the first structured string and the second structured string is calculated using a Siamese network to obtain a similarity value between the first structured string and the second structured string.

According to an embodiment of the present disclosure, the Siamese network is a neural network used to learn a similarity or dissimilarity within a pair of input data. The Siamese network includes two sub-networks and a similarity calculation layer for determining a similarity between input data. The two sub-networks have identical network structures and model parameters, so that input samples of the two sub-networks may be mapped to the same feature space, that is, the two sub-networks may extract features from their respective input data in the same way, so that a similarity between their respective input data may be determined by directly comparing a similarity between vectors respectively output by the two sub-networks.

According to an embodiment of the present disclosure, the two sub-networks in the Siamese network may process the first structured string and the second structured string respectively to determine a feature corresponding to the first structured string and a feature corresponding to the second structured string. The similarity value between the first structured string and the second structured string may be determined by comparing a similarity between the feature corresponding to the first structured string and the feature corresponding to the second structured string.

In operation S230, a performance evaluation result of the target model is obtained based on the similarity value between the first structured string and the second structured string.

According to an embodiment of the present disclosure, since the second structured string is determined by manually analyzing the object to be recognized in the annotated image, the second structured string may be regarded as a correct string representation of the object to be recognized.

According to an embodiment of the present disclosure, it is possible to determine a similarity value between the feature corresponding to the first structured string and the feature corresponding to the second structured string based on the similarity value between the first structured string and the second structured string. When the similarity value is higher than a predetermined similarity threshold, it may be determined that a formula represented by the first structured string and a formula represented by the second structured string have similar structures and identical semantics, and the performance evaluation result of the target model thus obtained may indicate that the performance of the target model meets the requirements.

According to an embodiment of the present disclosure, when the similarity value is lower than the predetermined similarity threshold, it may be determined that there is a semantic difference between the formula represented by the first structured string and the formula represented by the second structured string, and the performance evaluation result of the target model thus obtained may indicate that the performance of the target model does not meet the requirements.

According to an embodiment of the present disclosure, the annotated image is processed using the target model to obtain the first structured string corresponding to the object to be recognized, and the similarity between the first structured string and the second structured string obtained by annotating the object to be recognized is calculated using the Siamese network to obtain the similarity value between the first structured string and the second structured string, thereby determining the performance evaluation result of the target model. Since the second structured string is obtained by annotating the object to be recognized, the similarity value may represent a similarity value between the first structured string and the label of the object to be recognized, and the performance evaluation result obtained based on the similarity value may accurately and objectively evaluate the performance of the target model. In addition, evaluating the model performance using the similarity value may avoid the problem of an inaccurate decision of semantics and an incorrect evaluation of model performance caused by a method of, for example, evaluating an optical character recognition model using edit distance in which only a difference between strings is considered but the particularity of symbols in the object to be recognized is not considered, thereby further improving the accuracy of model performance evaluation.

According to an embodiment of the present disclosure, calculating the similarity between the first structured string and the second structured string using the Siamese network to obtain the similarity value between the first structured string and the second structured string may include: generating a first image based on the first structured string; generating a second image based on the second structured string; and inputting the first image and the second image into the Siamese network to obtain a similarity value between the first image and the second image, where the similarity value between the first structured string and the second structured string is represented by the similarity value between the first image and the second image.

According to an embodiment of the present disclosure, the first structured string is compiled to generate the first image corresponding to the first structured string, and the second structured string is compiled to generate the second image corresponding to the second structured string.

According to an embodiment of the present disclosure, the first image and the second image are input into the Siamese network, the first image is processed using one of the two sub-networks in the Siamese network, and the second image is processed using the other sub-network in the Siamese network, so as to respectively determine an image feature of the first image and an image feature of the second image.

According to an embodiment of the present disclosure, in the similarity calculation layer, a similarity value between the image feature of the first image and the image feature of the second image is determined using a similarity determination method, and the similarity value is used as the similarity value between the first structured string and the second structured string. The similarity determination method may include Euclidean distance, cosine similarity, contrastive loss and other methods.

According to an embodiment of the present disclosure, the first image and the second image are generated respectively based on the first structured string and the second structured string. The first image and the second image are then input into the Siamese network to determine the similarity value between the first image and the second image, which is used as the similarity value between the first structured string and the second structured string. By processing the first image and the second image using the Siamese network, it is possible to account for characteristics of structured strings and reduce the risk of incorrect determination caused by evaluating the model performance directly using the similarity between structured strings when the structured strings differ significantly but the first image and the second image represent the same semantics, thereby improving the accuracy and stability of the model performance evaluation.

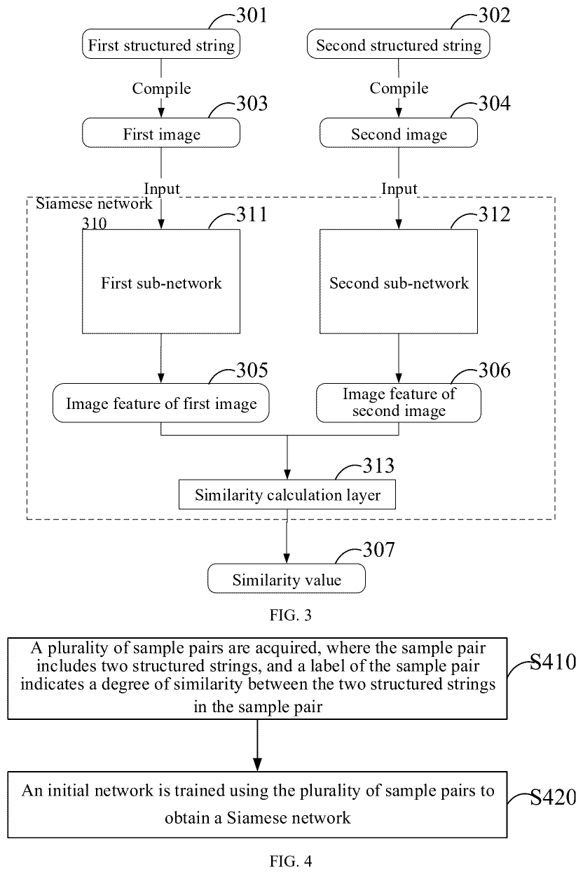

FIG. 3 schematically shows a flowchart of determining a similarity value according to an embodiment of the present disclosure.

As shown in FIG. 3, a Siamese network 310 includes a first sub-network 311, a second sub-network 312 and a similarity calculation layer 313, where the first sub-network 311 and the second sub-network 312 have completely identical network structures and network parameters. A first structured string 301 and a second structured string 302 are compiled respectively to obtain a first image 303 and a second image 304, which are input into the Siamese network 310. The first image 303 is processed by the first sub-network 311 of the Siamese network to determine an image feature 305 of the first image, and the second image 304 is processed by the second sub-network 312 of the Siamese network to determine an image feature 306 of the second image. Based on the image feature 305 of the first image and the image feature 306 of the second image, a similarity value 307 may be determined using the similarity calculation layer 313.

According to an embodiment of the present disclosure, the object to be recognized includes a formula object.

According to an embodiment of the present disclosure, the formula object typically contains a complex two-dimensional structure, in which characters may include various mathematical symbols, Greek letters, Latin letters, etc. in diverse forms, and a formula may contain many special symbols and structural combinations such as superscripts and subscripts, fractions, radicals, integrals, etc. Therefore, it is difficult to accurately recognize the formula object using traditional optical character recognition methods. The formula object may be used as the object to be recognized and may be recognized using the target model. The model performance may be evaluated according to a recognition effect of the target model.

FIG. 4 schematically shows a flowchart of a method for training a model according to an embodiment of the present disclosure.

As shown in FIG. 4, the method includes operation S410 to operation S420.

In operation S410, a plurality of sample pairs are acquired, where the sample pair includes two structured strings, and a label of the sample pair indicates a degree of similarity between the two structured strings in the sample pair.

According to an embodiment of the present disclosure, when the formula objects respectively corresponding to the two structured strings in the sample pair have identical semantics, the label of the sample pair indicates a high degree of similarity between the two structured strings in the sample pair. In contrast, when the formula objects respectively corresponding to the two structured strings in the sample pair have different semantics, the label of the sample pair indicates a low degree of similarity between the two structured strings in the sample pair.

According to an embodiment of the present disclosure, the label of the sample pair may be a label for a binary classification problem, that is, when the label of the sample pair indicates a high degree of similarity between the two structured strings in the sample pair, it may be assigned a value of 1, while when the label of the sample pair indicates a low degree of similarity between the two structured strings in the sample pair, it may be assigned a value of 0.

In operation S420, an initial network is trained using the plurality of sample pairs to obtain a Siamese network.

According to an embodiment of the present disclosure, the initial network has the same network structure as the Siamese network, including two sub-networks with the same network structure and an initial similarity calculation layer for determining the similarity between input data.

According to an embodiment of the present disclosure, the plurality of sample pairs may be input into the initial network. For two structured strings included in each sample pair, a first structured string is processed by a first subnetwork, and a second structured string is processed by a second subnetwork, so as to respectively determine features of the two structured strings. Based on the features of the two structured strings, a similarity value between the two structured strings may be determined by the initial similarity calculation layer.

According to an embodiment of the present disclosure, the model parameters of the initial network may be adjusted based on the similarity value and the label of the sample pair until the similarity value output by the network matches the label of the sample pair, and the Siamese network is determined based on the current model parameters.

According to an embodiment of the present disclosure, the Siamese network is obtained by training the initial network using the plurality of sample pairs and the degree of similarity between the two structured strings in the sample pair. The sample pair may simulate the input data in an application process of the Siamese network, and the adjusted Siamese network may output a similarity value matching the label of the sample pair, so that the accuracy of the similarity value output by the Siamese network may be improved when evaluating the model performance using the Siamese network.

According to an embodiment of the present disclosure, the method for training a model further includes: generating the plurality of sample pairs based on a plurality of initial structured strings.

According to an embodiment of the present disclosure, the initial structured string may include a structured string obtained by manually annotating according to the formula object, and the initial structured string may be determined by selecting a formula sample from a thesis dataset.

According to an embodiment of the present disclosure, for each initial structured string, it is possible to determine one or more strings different from the initial structured string. The strings corresponding to the same initial structured string may be combined multiple times to determine a plurality of sample pairs.

According to an embodiment of the present disclosure, by determining one or more strings corresponding to each initial structured string based on a plurality of initial structured strings and combining the strings corresponding to the same initial structured string multiple times to determine a plurality of sample pairs, it is possible to construct a dataset including a large number of sample pairs based on the plurality of initial structured strings, thereby achieving data augmentation, increasing the number of datasets in the training process, reducing overfitting, and improving a generalization ability of the Siamese model.

According to an embodiment of the present disclosure, generating the plurality of sample pairs based on the plurality of initial structured strings may include: performing multiple field embedding operations at a plurality of embeddable positions of the initial structured string based on a predefined field to obtain a plurality of first structured strings; performing multiple field replacement operations at a plurality of replaceable positions of the initial structured string to obtain a plurality of second structured strings; and generating the plurality of sample pairs based on the plurality of first structured strings and the plurality of second structured strings.

According to an embodiment of the present disclosure, the predefined field includes a field that does not affect the semantics of the formula object corresponding to the structured string but only adjust the format or typesetting of the formula object, such as the field “\mathrm{ }” for setting text or mathematical symbols to Roman font, the field “\quad” for adding spaces, and the like.

According to an embodiment of the present disclosure, the initial structured string may include a plurality of fields, and a position between two adjacent fields may be determined as an embeddable position, thereby determining a plurality of embeddable positions in the initial structured string.

According to an embodiment of the present disclosure, the predefined field may be embedded at any embeddable position to complete an embedding operation. Multiple field embedding operations may be performed at a plurality of embeddable positions in the initial structured string to obtain a plurality of first structured strings. Each first structured string may be obtained by performing one or more field embedding operations on the initial structured string, and the first structured string has the same semantics as the initial structured string.

According to an embodiment of the present disclosure, in the initial structured string, variables in each field may be determined as replaceable positions. For example, in the field “\partial x_1”, the “\partial” represents a partial derivative symbol. If the letters in the symbol are replaced, the obtained structured string may fail to compile, so such field is not replaceable. However, if “x” and “1” are replaced, the obtained structured string may be compiled normally, so such field is considered variables.

According to an embodiment of the present disclosure, multiple field replacement operations may be performed at a plurality of replaceable positions in the initial structured string to obtain a plurality of second structured strings, where each second structured string may be obtained by performing one or more field replacement operations on the initial structured string, and the second structured string has different semantics from the initial structured string.

According to an embodiment of the present disclosure, it is also possible to perform multiple field embedding operations at a plurality of embeddable positions in the second structured string to increase a complexity of the second structured string.

According to an embodiment of the present disclosure, it is also possible to perform multiple field deletion operations on a plurality of deletable fields in the initial structured string to obtain a plurality of second structured strings, where a deletable field is a field in the initial structured string whose removal does not affect a normal compilation of the new structured string. The second structured string obtained through the field deletion operation has different semantics from the initial structured string.

According to an embodiment of the present disclosure, after performing multiple operations on the initial structured string to obtain a plurality of first structured strings and a plurality of second structured strings, it is possible to perform multiple combinations based on the plurality of first structured strings and the plurality of second structured strings to generate a plurality of sample pairs, where each sample pair may be formed by combining two different first structured strings or by combining a first structured string and a second structured string.

According to an embodiment of the present disclosure, the first structured string is obtained by performing field embedding operations on the initial structured string using fields that do not affect formula semantics, so that the first structured string has the same semantics as the initial structured string, and the first structured string is a positive sample with respect to the initial structured string. The second structured string is obtained by performing field replacement operations on the initial structured string, so that the second structured string has different semantics from the initial structured string, and the second structured string is a negative sample with respect to the initial structured string. By generating a plurality of positive samples and a plurality of negative samples through field processing of the initial structured string and by determining sample pairs, the number of sample pairs may be increased, thereby achieving data augmentation.

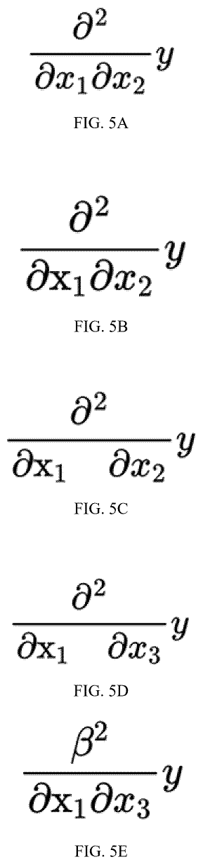

FIG. 5A schematically shows an image of a formula object compiled from an initial structured string according to an embodiment of the present disclosure.

As shown in FIG. 5A, the formula object may be obtained by compiling the initial structured string “\frac{\partial\hat{ }2} {\partial x_1\partial x_2}y”.

FIG. 5B schematically shows an image of a formula object compiled from a first structured string according to an embodiment of the present disclosure.

As shown in FIG. 5B, a predefined field “\mathrm{ }” is embedded at the embeddable position between “\frac{\partial\hat{ }2}” and “\partial x_1” in the initial structured string, and the field “\partial x_1” following the predefined field is written into the curly brackets of the predefined field as a parameter of the predefined field, thus obtaining the first structured string “\frac{\partial\hat{ }2} {\mathrm{\partial x_1}\partial x_2}y”. The first structured string may be compiled to obtain a formula object, in which the “x₁” in the denominator of the formula object appears in Roman font because the field “\partial x_1” in the first structured string is a parameter of the predefined field “\mathrm{ }”. The obtained formula object differs from the image for the formula object corresponding to the initial structured string but expresses the same semantics.

FIG. 5C schematically shows an image of a formula object compiled from a first structured string according to another embodiment of the present disclosure.

As shown in FIG. 5C, the predefined field “\mathrm{ }” is embedded at the embeddable position between “\frac{\partial\hat{ }2}” and “\partial x_1” in the initial structured string, and the field “\partial x_1” following the predefined field is written into the curly brackets of the predefined field as a parameter of the predefined field. Then, a predefined field “\quad” is embedded at the embeddable position between the field “\partial x_1” and the field “\partial x_2”, thus obtaining another first structured string “\frac{\partial\hat{ }2} {\mathrm{\partial x_1}\quad\partial x_2}y”. The first structured string may be compiled to obtain a formula object, in which the “x₁” in the denominator of the formula object 503 appears in Roman font because the field “\partial x_1” in the first structured string is a parameter of the predefined field “\mathrm{ }”, and there is a space between the partial derivative symbol for x₁ and the partial derivative symbol for x₂ due to the “\quad” between the field “\partial x_1” and the field “\partial x_2”. The obtained formula object differ from the image for the formula object corresponding to the initial structured string but expresses the same semantics.

FIG. 5D schematically shows an image of a formula object compiled from a second structured string according to an embodiment of the present disclosure.

As shown in FIG. 5D, the predefined field “\mathrm{ }” is embedded at the embeddable position between “\frac{\partial\hat{ }2}” and “\partial x_1” in the initial structured string, and the field “\partial x_1” following the predefined field is written into the curly brackets of the predefined field as a parameter of the predefined field. The field “x_2” is replaced by “x_3” through a field replacement operation, thus obtaining a second structured string “\frac{\partial\hat{ }2} {\mathrm{\partial x_1}\quad\partial x_3}y”. The second structured string may be compiled to obtain a formula object. In the obtained formula object, the “x₁” in the denominator appears in Roman font because the field “\partial x_1” in the first structured string is a parameter of the predefined field “\mathrm{ }”, which does not affect the semantics of the formula object, but “x₂” is changed to “x₃” in the partial derivative, which alters the semantics of the formula object.

FIG. 5E schematically shows an image of a formula object compiled from another second structured string according to an embodiment of the present disclosure.

As shown in FIG. 5E, the predefined field “\mathrm{ }” is embedded at the embeddable position between “\frac{\partial\hat{ }2}” and “\partial x_1” in the initial structured string, and the field “\partial x_1” following the predefined field is written into the curly brackets of the predefined field as a parameter of the predefined field. The field “\partial\hat{ }2” is replaced by “\beta{ } \hat{ }2” through a field replacement operation, thus obtaining a second structured string “\frac{\beta{ } \hat{ }2} {\mathrm{\partial x_1}\ partial x_3}y”. The second structured string may be compiled to obtain a formula object. In the obtained formula object, the “x₁” in the denominator appears in Roman font because the field “\partial x_1” in the first structured string is a parameter of the predefined field “\mathrm{ }”, which does not affect the semantics of the formula object, but the partial derivative symbol is changed to β in the numerator, which alters the semantics of the formula object.

According to an embodiment of the present disclosure, the sample pairs include positive pairs and negative pairs. Generating the plurality of sample pairs based on the plurality of first structured strings and the plurality of second structured strings obtained from the plurality of initial structured strings may include: generating a positive sample pair based on two first target structured strings determined from the plurality of first structured strings; and generating a negative sample pair based on a second target structured string determined from the plurality of first structured strings and a third target structured string determined from the plurality of second structured strings.

According to an embodiment of the present disclosure, the sample pairs include positive pairs and negative pairs. The positive sample pair includes two structured strings with the same semantics, and the negative sample pair includes two structured strings with different semantics.

According to an embodiment of the present disclosure, two different first structured strings are determined from the plurality of first structured strings as the two first target structured strings. Since both first structured strings have the same semantics as the initial structured string, a positive sample pair may be generated based on the two first structured strings.

According to an embodiment of the present disclosure, a first structured string is determined from the plurality of first structured strings as the second target structured string, and a second structured string is determined from the plurality of second structured strings as the third target structured string. Since the second target structured string has the same semantics as the initial structured string and the third target structured string has different semantics from the initial structured string, the second target structured string and the third target structured string have different semantics. Therefore, a negative sample pair may be generated based on the second target structured string and the third target structured string.

According to an embodiment of the present disclosure, the positive sample pair is formed using two generated first structured strings with the same semantics, and the negative sample pair is formed using a generated second target structured string and a generated third target structured string with different semantics, thus the correctness of the label of the sample pair may be ensured, thereby improving the efficiency and effectiveness of model training, and resulting in a Siamese network that meets the requirements.

According to an embodiment of the present disclosure, training the initial network using a plurality of sample pairs to obtain a Siamese network includes: generating two sample images based on the two structured strings in the sample pair; inputting the two sample images into the initial network to obtain a similarity value of the sample pair; obtaining a loss value based on the similarity values of the plurality of sample pairs and the labels of the plurality of sample pairs; and adjusting model parameters of the initial network based on the loss value to obtain the Siamese network.

According to an embodiment of the present disclosure, the two structured strings in the sample pair are compiled to generate two sample images respectively corresponding to the two structured strings. The two sample images are input into the initial network. A first sample image is processed by a first sub-network, and a second sample image is processed by a second sub-network, thereby obtaining respective sample features of the two sample images. A similarity value between the two sample images may be determined based on the sample features, and the similarity value is determined as the similarity value of the sample pair.

According to an embodiment of the present disclosure, the loss value for the sample pair is determined based on the similarity value of the sample pair and the label of the sample pair. As mentioned above, the label of the sample pair may be a label 0 or 1 for a binary classification task, that is, when the label of the sample pair indicates a high degree of similarity between the two structured strings in the sample pair, it may be assigned a value of 1, while when the label of the sample pair indicates a low degree of similarity between the two structured strings in the sample pair, it may be assigned a value of 0. Accordingly, when the label is assigned a value of 1, the similarity value of the sample pair is high, and the closer the similarity value to 1, the better the performance of the initial network. In contrast, when the label is assigned a value of 0, the similarity value of the sample pair is low, and the closer the similarity value to 0, the worse the performance of the initial network. The loss value for the sample pair may be determined by an absolute value of a difference between the similarity value of the sample pair and the label of the sample pair.

According to an embodiment of the present disclosure, the model parameters of the initial network are adjusted based on the loss value to obtain the Siamese network.

According to an embodiment of the present disclosure, the loss value is determined based on the similarity value of the sample pair and the label of the sample pair, and the model parameters of the initial network are adjusted based on the loss value to determine the Siamese network. By searching for a combination of model parameters that minimizes the loss value, the performance of the model on the training data may be improved. Since the training data is the same as the input data used during application, the performance of the Siamese network during model performance evaluation may be improved.

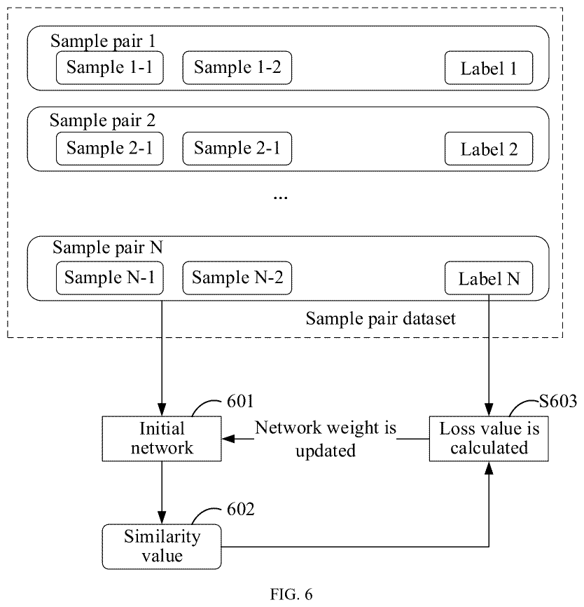

FIG. 6 schematically shows a schematic diagram of adjusting model parameters of an initial network according to an embodiment of the present disclosure.

As shown in FIG. 6, a sample pair dataset includes N sample pairs, and each sample pair includes two samples and a label of the sample pair. For example, sample pair N includes sample N−1 and sample N−2 as well as label N.

The two samples in the sample pair are processed using an initial network 601 to determine a similarity value 602 of the sample pair. According to the similarity value 602 and the label of the sample pair, operation S603 is performed on the sample pair to calculate a loss value, and model parameters of the initial network are updated based on the loss value. If the loss value is greater than a predetermined loss threshold, the model parameters of the initial network may be adjusted based on the loss value until a new loss value obtained after processing with the adjusted network is less than the loss threshold. The adjustment of the model parameters is then stopped, and the Siamese network is obtained.

According to an embodiment of the present disclosure, the method for training a model further includes: in response to the loss value being greater than a predetermined threshold, determining at least one target sample pair related to the loss value; and removing the at least one target sample pair from the plurality of sample pairs.

According to an embodiment of the present disclosure, after multiple rounds of model parameter adjustments, it may be considered that the model already has good performance. In this case, if the loss value still exceeds the predetermined threshold, the cause may not be related to the model performance, but rather due to noise in sample pairs. It is possible to determine the sample pair corresponding to the noise based on the magnitude of the loss values obtained from different sample pairs, and remove that sample pair to perform data cleaning.

According to an embodiment of the present disclosure, the model training operations described above are performed using the model obtained after multiple rounds of parameter adjustments or the Siamese network obtained after the parameter adjustment is completed. When the loss value is greater than the predetermined threshold, the sample pair that results in the loss value greater than the predetermined threshold is determined as a target sample pair, and the target sample pair is removed from the plurality of sample pairs. Preferably, the predetermined threshold may be set to 0.8.

According to an embodiment of the present disclosure, by checking and cleaning potential dirty data in the plurality of sample pairs based on the loss value obtained from the model after multiple rounds of model parameter adjustments, it is possible to reduce the likelihood of dirty data in the training data, thereby improving the accuracy of the training data and enhancing the efficiency of model training and the performance of the trained Siamese network.

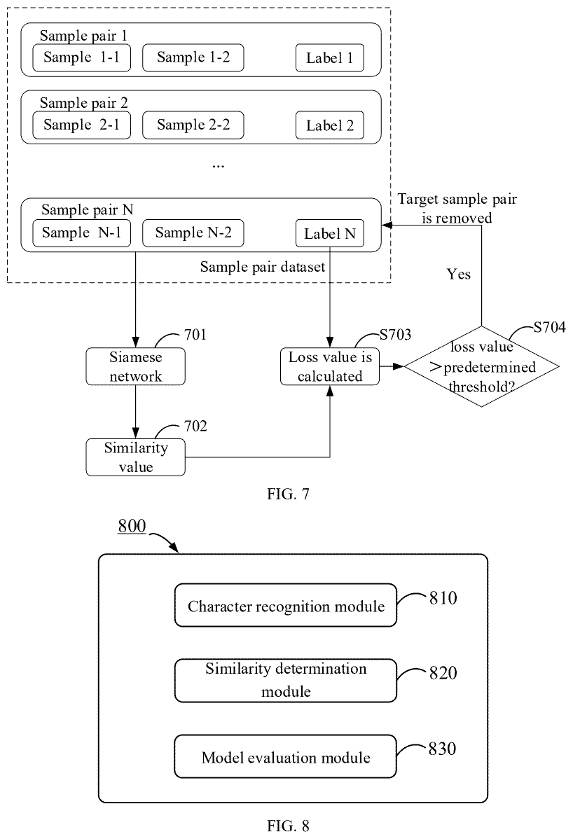

FIG. 7 schematically shows a schematic diagram of removing a target sample pair from a training set according to an embodiment of the present disclosure.

As shown in FIG. 7, a sample pair dataset includes N sample pairs, where each sample pair includes two samples and a label of the sample pair. For example, sample pair N includes sample N−1 and sample N−2 as well as label N.

The two samples in the sample pair are processed by a Siamese network 701 to determine a similarity value 702 of the sample pair. Based on the similarity value 702 and the label of the sample pair, operation S703 is performed to calculate a loss value of the sample pair, and operation S704 is performed to determine a magnitude relationship between the loss value and a predetermined threshold. When the loss value is greater than the predetermined threshold, the sample pair that results in the loss value is determined as a target sample pair, and the target sample pair is then removed from the sample pair dataset based on the target sample pair.

FIG. 8 schematically shows a block diagram of an apparatus for evaluating model performance according to an embodiment of the present disclosure.

As shown in FIG. 8, an apparatus 800 for evaluating model performance of the embodiment includes a character recognition module 810, a similarity determination module 820 and a model evaluation module 830.

The character recognition module 810 is used to, in response to a model performance evaluation request for a target model, perform optical character recognition on an object to be recognized contained in an annotated image using the target model to obtain a first structured string, where a label of the annotated image is a second structured string obtained by annotating the object to be recognized.

The similarity determination module 820 is used to calculate a similarity between the first structured string and the second structured string using a Siamese network to obtain a similarity value between the first structured string and the second structured string.

The model evaluation module 830 is used to obtain a performance evaluation result of the target model based on the similarity value between the first structured string and the second structured string.

According to an embodiment of the present disclosure, the similarity determination module 820 includes a first image generation sub-module, a second image generation sub-module and a similarity determination sub-module.

The first image generation sub-module is used to generate a first image based on the first structured string.

The second image generation sub-module is used to generate a second image based on the second structured string.

The similarity determination sub-module is used to input the first image and the second image into the Siamese network to obtain a similarity value between the first image and the second image, where the similarity value between the first structured string and the second structured string is represented by the similarity value between the first image and the second image.

According to an embodiment of the present disclosure, the object to be recognized includes a formula object.

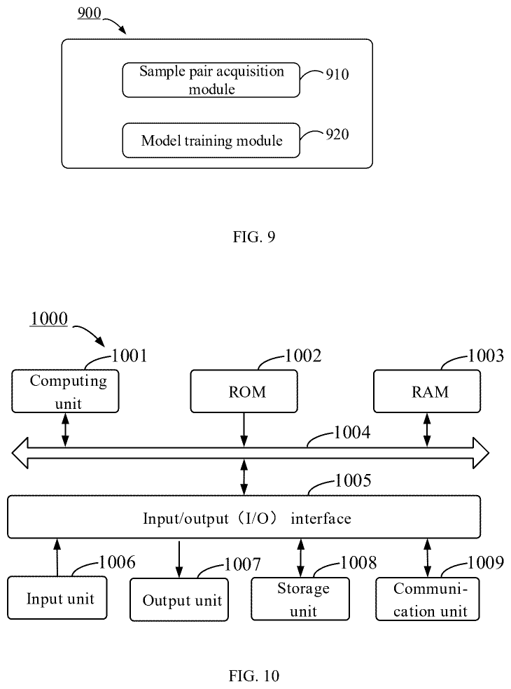

FIG. 9 schematically shows a block diagram of an apparatus for training a model according to an embodiment of the present disclosure.

As shown in FIG. 9, an apparatus 900 for training a model in the embodiment includes a sample pair acquisition module 910 and a model training module 920.

The sample pair acquisition module 910 is used to acquire a plurality of sample pairs, where the sample pair includes two structured strings, and a label of the sample pair indicates a degree of similarity between the two structured strings in the sample pairs.

The model training module 920 is used to train an initial network using the plurality of sample pairs to obtain a Siamese network.

According to an embodiment of the present disclosure, the apparatus 900 for training a model further includes a sample pair generation module.

The sample pair generation module is used to generate the plurality of sample pairs based on a plurality of initial structured strings.

According to an embodiment of the present disclosure, the sample pair generation module includes a field embedding sub-module, a field replacement sub-module and a sample pair generation sub-module.

The field embedding sub-module is used to perform multiple field embedding operations at a plurality of embeddable positions in the initial structured string based on predefined fields to obtain a plurality of first structured strings.

The field replacement sub-module is used to perform multiple field replacement operations at a plurality of replaceable positions in the initial structured string to obtain a plurality of second structured strings.

The sample pair generation sub-module is used to generate the plurality of sample pairs based on the plurality of first structured strings and the plurality of second structured strings.

According to an embodiment of the present disclosure, the sample pairs include positive sample pairs and negative sample pairs; and the sample pair generation sub-module includes a positive sample pair generation unit and a negative sample pair generation unit.

The positive sample pair generation unit is used to generate a positive sample pair based on two first target structured strings determined from the plurality of first structured strings.

The negative sample pair generation unit is used to generate a negative sample pair based on a second target structured string determined from the plurality of first structured strings and a third target structured string determined from the plurality of second structured strings.

According to an embodiment of the present disclosure, the model training module 920 includes an image generation sub-module, an image input sub-module, a loss value determination sub-module and a parameter adjustment sub-module.

The image generation sub-module is used to generate two sample images based on the two structured strings in the sample pair.

The image input sub-module is used to input the two sample images into the initial network to obtain a similarity value of the sample pair.

The loss value determination sub-module is used to obtain the loss value based on the similarity values of the plurality of sample pairs and the labels of the plurality of sample pairs.

The parameter adjustment sub-module is used to adjust the model parameters of the initial network based on the loss value to obtain the Siamese network.

According to an embodiment of the present disclosure, the apparatus 900 for training a model further includes a target sample pair determination module and a target sample pair removal module.

The target sample pair determination module is used to determine at least one target sample pair related to the loss value when the loss value is greater than the predetermined threshold.

The target sample pair removal module is used to remove the at least one target sample pair from the plurality of sample pairs.

According to an embodiment of the present disclosure, the present disclosure further provides an electronic device, a readable storage medium, and a computer program product.

According to an embodiment of the present disclosure, an electronic device is provided, including: at least one processor; and a memory communicatively connected to the at least one processor. The memory stores instructions executable by the at least one processor, and the instructions are used to, when executed by the at least one processor, cause the at least one processor to implement the methods described above.

According to an embodiment of the present disclosure, a non-transitory computer-readable storage medium having computer instructions therein is provided, and the computer instructions are used to cause a computer to implement the methods described above.

According to an embodiment of the present disclosure, a computer program product containing a computer program is provided, and the computer program is used to, when executed by a processor, cause the processor to implement the methods described above.

FIG. 10 schematically shows a block diagram of an electronic device suitable for implementing the method for evaluating model performance and the method for training a model according to an embodiment of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 10, the electronic device 1000 includes a computing unit 1001 which may perform various appropriate actions and processes according to a computer program stored in a read only memory (ROM) 1002 or a computer program loaded from a storage unit 1008 into a random access memory (RAM) 1003. In the RAM 1003, various programs and data necessary for an operation of the electronic device 1000 may also be stored. The computing unit 1001, the ROM 1002 and the RAM 1003 are connected to each other through a bus 1004. An input/output (I/O) interface 1005 is also connected to the bus 1004.

A plurality of components in the electronic device 1000 are connected to the I/O interface 1005, including: an input unit 1006, such as a keyboard, or a mouse; an output unit 1007, such as displays or speakers of various types; a storage unit 1008, such as a disk, or an optical disc; and a communication unit 1009, such as a network card, a modem, or a wireless communication transceiver. The communication unit 1009 allows the electronic device 1000 to exchange information/data with other devices through a computer network such as Internet and/or various telecommunication networks.

The computing unit 1001 may be various general-purpose and/or dedicated processing assemblies having processing and computing capabilities. Some examples of the computing units 1001 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 1001 executes various methods and processes described above, such as the method for evaluating model performance and the method for training a model. For example, in some embodiments, the method for evaluating model performance and the method for training a model may be implemented as a computer software program which is tangibly embodied in a machine-readable medium, such as the storage unit 1008. In some embodiments, the computer program may be partially or entirely loaded and/or installed in the electronic device 1000 via the ROM 1002 and/or the communication unit 1009. The computer program, when loaded in the RAM 1003 and executed by the computing unit 1001, may execute one or more steps in the method for evaluating model performance and the method for training a model described above. Alternatively, in other embodiments, the computing unit 1001 may be used to perform the method for evaluating model performance and the method for training a model by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the method for evaluating model performance and the method for training a model of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method for evaluating model performance, comprising:
in response to a model performance evaluation request for a target model, performing optical character recognition on an object to be recognized contained in an annotated image using the target model to obtain a first structured string, wherein a label of the annotated image is a second structured string obtained by annotating the object to be recognized;
calculating a similarity between the first structured string and the second structured string using a Siamese network to obtain a similarity value between the first structured string and the second structured string; and
obtaining a performance evaluation result of the target model based on the similarity value between the first structured string and the second structured string.

2. The method according to claim 1, wherein the calculating a similarity between the first structured string and the second structured string using a Siamese network to obtain a similarity value between the first structured string and the second structured string comprises:
generating a first image based on the first structured string;
generating a second image based on the second structured string; and
inputting the first image and the second image into the Siamese network to obtain a similarity value between the first image and the second image, wherein the similarity value between the first structured string and the second structured string is represented by the similarity value between the first image and the second image.

3. The method according to claim 1, wherein the object to be recognized comprises a formula object.

4. A method for training a model, comprising:
acquiring a plurality of sample pairs, wherein the sample pair comprises two structured strings, and a label of the sample pair indicates a degree of similarity between the two structured strings in the sample pair; and
training an initial network using the plurality of sample pairs to obtain a Siamese network.

5. The method according to claim 4, further comprising:
generating the plurality of sample pairs based on a plurality of initial structured strings.

6. The method according to claim 5, wherein the generating the plurality of sample pairs based on a plurality of initial structured strings comprises:
performing multiple field embedding operations at a plurality of embeddable positions in the initial structured string based on a predefined field to obtain a plurality of first structured strings;
performing multiple field replacement operations at a plurality of replaceable positions in the initial structured string to obtain a plurality of second structured strings; and
generating the plurality of sample pairs based on the plurality of first structured strings and the plurality of second structured strings.

7. The method according to claim 6, wherein the sample pairs comprise positive sample pairs and negative sample pairs, and the generating the plurality of sample pairs based on the plurality of first structured strings and the plurality of second structured strings obtained from the plurality of initial structured strings comprises:
generating the positive sample pair based on two first target structured strings determined from the plurality of first structured strings; and
generating the negative sample pair based on a second target structured string determined from the plurality of first structured strings and a third target structured string determined from the plurality of second structured strings.

8. The method according to claim 4, wherein the training an initial network using the plurality of sample pairs to obtain a Siamese network comprises:
generating two sample images based on the two structured strings in the sample pair;
inputting the two sample images into the initial network to obtain a similarity value of the sample pair;
obtaining a loss value based on the similarity values of the plurality of sample pairs and the labels of the plurality of sample pairs; and
adjusting model parameters of the initial network based on the loss value to obtain the Siamese network.

9. The method according to claim 8, further comprising:
in response to the loss value being greater than a predetermined threshold, determining at least one target sample pair related to the loss value; and
removing the at least one target sample pair from the plurality of sample pairs.

10. An electronic device, comprising:
at least one processor; and
a memory communicatively connected to the at least one processor, wherein the memory stores instructions executable by the at least one processor, and the instructions are configured to, when executed by the at least one processor, cause the at least one processor to:
in response to a model performance evaluation request for a target model, perform optical character recognition on an object to be recognized contained in an annotated image using the target model to obtain a first structured string, wherein a label of the annotated image is a second structured string obtained by annotating the object to be recognized;
calculate a similarity between the first structured string and the second structured string using a Siamese network to obtain a similarity value between the first structured string and the second structured string; and
obtain a performance evaluation result of the target model based on the similarity value between the first structured string and the second structured string.

11. The electronic device according to claim 10, wherein the at least one processor is further configured to:
generate a first image based on the first structured string;
generate a second image based on the second structured string; and
input the first image and the second image into the Siamese network to obtain a similarity value between the first image and the second image, wherein the similarity value between the first structured string and the second structured string is represented by the similarity value between the first image and the second image.

12. The electronic device according to claim 10, wherein the object to be recognized comprises a formula object.

13. An electronic device, comprising:
at least one processor; and
a memory communicatively connected to the at least one processor, wherein the memory stores instructions executable by the at least one processor, and the instructions are configured to, when executed by the at least one processor, cause the at least one processor to implement the method of claim 4.

14. The electronic device according to claim 13, wherein the at least one processor is further configured to:
generate the plurality of sample pairs based on a plurality of initial structured strings.

15. The electronic device according to claim 14, wherein the at least one processor is further configured to:
perform multiple field embedding operations at a plurality of embeddable positions in the initial structured string based on a predefined field to obtain a plurality of first structured strings;
perform multiple field replacement operations at a plurality of replaceable positions in the initial structured string to obtain a plurality of second structured strings; and
generate the plurality of sample pairs based on the plurality of first structured strings and the plurality of second structured strings.

16. The electronic device according to claim 15, wherein the sample pairs comprise positive sample pairs and negative sample pairs, and wherein the at least one processor is further configured to:
generate the positive sample pair based on two first target structured strings determined from the plurality of first structured strings; and
generate the negative sample pair based on a second target structured string determined from the plurality of first structured strings and a third target structured string determined from the plurality of second structured strings.

17. The electronic device according to claim 13, wherein the at least one processor is further configured to:
generate two sample images based on the two structured strings in the sample pair;
input the two sample images into the initial network to obtain a similarity value of the sample pair;
obtain a loss value based on the similarity values of the plurality of sample pairs and the labels of the plurality of sample pairs; and
adjust model parameters of the initial network based on the loss value to obtain the Siamese network.

18. The electronic device according to claim 17, wherein the at least one processor is further configured to:
in response to the loss value being greater than a predetermined threshold, determine at least one target sample pair related to the loss value; and
remove the at least one target sample pair from the plurality of sample pairs.

19. A non-transitory computer-readable storage medium having computer instructions therein, wherein the computer instructions, when executed by a processor, are configured to cause a computer to implement the method of claim 1.

20. A non-transitory computer-readable storage medium having computer instructions therein, wherein the computer instructions, when executed by a processor, are configured to cause a computer to implement the method of claim 4.
